(19) United States
(12) Patent Application Publication
(10) Pub. No.: US 2004/0093297 A1
(43) Pub. Date: May 13, 2004

(54) Arbitrage fund program

(75) Inventors: George L. Strobel II, Memphis, TN (US); M. Guion Bond, Houston, TX (US)

Correspondence Address: Michael S. Pavento, Esq., KING & SPALDING LLP, 45th Floor, 191 Peachtree Street, N.E., Atlanta, GA, 30303, US

(73) Assignee: The Perigee Group, Memphis, TN

(21) Appl. No.: 10/696,985

(22) Filed: Oct. 30, 2003

Related U.S. Application Data
(63) Continuation-in-part of application No. 10/628,196, filed on Jul. 28, 2003.
(60) Provisional application No. 60/414,988, filed on Oct. 1, 2002.

(51) Int. Cl. G06F 17/60

(52) U.S. Cl. 705/36

(57) ABSTRACT

An arbitrage entity is formed to manage arbitrage transactions. The arbitrage entity owns an interest in one or more leveraged annuity and one or more leveraged life insurance policy issued on the life of one or more client. Premium payments on the leveraged life insurance are financed by annuity proceeds. A capital infusion is obtained to purchase the leveraged annuity or annuities and the leveraged life insurance. The capital infusion amount is less than the death benefit of the leveraged life insurance. Upon death of the client(s), the death benefit and remaining assets of the arbitrage entity are net arbitrage proceeds. Net arbitrage proceeds are distributed in accordance with ownership interests in the arbitrage entity.

### RELATED APPLICATIONS

This application is a continuation-in-part of co-pending U.S. patent application Ser. No. 10/628,196 entitled “Variable Insurance Annuity Fund Program” and filed Jul. 28, 2003, which claims the benefit of U.S. Provisional Patent Application Serial No. 60/414,988, entitled “Variable Insurance Annuity Fund Program” and filed Oct. 1, 2002, and which is entirely incorporated herein by reference.

### TECHNICAL FIELD

The present invention relates to arbitrage investment products. More particularly, the present invention relates to arbitrage investment products designed for capitalizing on potential arbitrage benefits between the life insurance markets and the annuity markets.

### BACKGROUND OF THE INVENTION

Over the last decade the insurance industry has developed and popularized variable life insurance products. By design, any investments derived from premium payments toward a variable life insurance product are held in a segregated account of the insurance company and returns inure exclusively to the benefit or detriment of the variable policy holder. Thus, variable life insurance products offer a significant benefit over traditional whole life insurance products, in which any returns on underlying investments are credited to the insurance company at large and the specific policy is credited with a rate of return reflective of the insurance company's overall average return. As another benefit, variable life insurance policy owners are often given a limited ability to select how their policy premiums are invested. For example, variable life insurance policy owners may be allowed to allocate their premiums and policy balances among various investment funds offered by the insurance company.

Investment funds used to support variable life insurance products are typically managed by investment advisors selected by the insurance company. The insurance company determines the types and number of available investment funds prior to selling the variable life insurance product to the policy owner. At their inception, fairly basic bond and/or equity funds were used to support most variable life insurance products and policy owners were typically given only two or three choices of such funds. However, as the variable life insurance product has matured in the marketplace, the investment options have become far more sophisticated.

Most types of investments available to the general public have now been replicated as investment options used to support variable life insurance products. In addition, variable life insurance products are now being sold based on the perceived skills and capabilities of the investment advisors managing the policies' investments as much as for their insurance coverage. Thus, at one extreme, some variable life insurance products have evolved from what was initially intended to be a better performing form of life insurance over traditional whole life insurance into a tax efficient vehicle for holding a portion of an individual's investment portfolio. As long as the investments are held inside an individual's variable insurance policy and the policy qualifies as life insurance under the Internal Revenue Code, investment income and capital accumulation inside the policy are not subject to income tax.

In order to qualify as life insurance under the Internal Revenue Code, an insurance product must provide a minimum death benefit and meet certain diversification requirements. If a variable life insurance policy is not adequately diversified, the policy will not qualify as life insurance under the Internal Revenue Code, and the owner of the policy must recognize ordinary income each year equal to the annual increase in cash value over the premiums paid into the policy for that year. In addition, the Internal Revenue Code requires that the variable life insurance product, not the policyholder, own and control the underlying investments. If the policyholder “controls” the investment of funds in the segregated account, the policyholder will be treated under the Internal Revenue Code as the direct owner of the underlying segregated account assets. Through careful design and constant monitoring of a variable insurance product's compliance with these requirements, insurance companies are able to offer clients variable life insurance products that closely match the client's investment preferences.

Insurance providers continue to develop innovative variable life insurance products designed to meet the strict requirements imposed by the Internal Revenue Code, while providing clients with investment structures to meet specific client preferences. One such product is known as a private placement policy. A private placement policy is a variable life insurance policy that effectively allows a client to inform the insurance provider of preferred investment funds, including preferred asset classes, preferred management styles and possibly even specific preferred fund managers. The insurance company then structures a variable life insurance policy that incorporates as many of the client's preferences as possible or practical. When the variable life insurance policy is written and executed, the resulting premiums are invested consistent with the client's desired investment preferences within the options available under the policy. Again, due to the investor control rules discussed above, investment funds used to support private placement policies may be substantially similar to publicly available funds, but are typically only available through the segregated accounts of the insurance company.

Private placement variable life insurance policies have thus allowed policyholders to gain access to certain investment portfolio characteristics inside a tax efficient variable life insurance wrapper. However, prior to the present invention, there remained at least one investment objective that was not successfully adapted to a variable insurance framework. Specifically, variable life insurance products had not been successfully designed to derive the arbitrage benefits that exist between the life insurance markets and the annuity markets. Such “arbitrage,” as the term is used herein, refers to the potential yield differential between life insurance products and annuity products, which can result from factors such as prevailing interest rates and different assumptions relied upon by issuers of life insurance and issuers of annuities.

The above-mentioned arbitrage opportunity exists in part because an annuity contract and an insurance contract are economic opposites. As a simple illustration, an individual might purchase an annuity contract for $100 and receive a 10% annuity proceed payment of $10 annually during the remainder of his lifetime. As the economic opposite of the annuity arrangement, a life insurance contract might require an individual to pay to the insurance company an insurance premium of $10 annually for the remainder of his lifetime, in order to receive a death benefit equal to the future value of $100 at the individual's actuarially assumed date of death. In this example, if instead of yielding annual annuity proceeds of 10%, the annuity contract yields annual annuity proceeds of 11% and if the death benefit of the life insurance policy is supported by an annual premium of $9 instead of $10, an annual $2 arbitrage opportunity would exist.

The competitive nature of the insurance industry may compel a company that specializes in issuing life insurance to offer products that have lower associated premiums than those charged by other carriers. The insurance company may rationalize its lower premiums by using different underwriting assumptions than its competitors, such as assumptions concerning higher investment returns or assumptions concerning lower mortality costs and/or administrative costs than those of competitors. Correspondingly, companies specializing in the issuance of annuity contracts frequently quote higher payout rates than other issuers of annuities. Implicit in these rates can be a combination of shorter life expectancy assumptions, higher earnings assumptions and possibly lower administrative and selling costs.

The arbitrage between annuity contracts and life insurance contracts can, in some cases, be so significant that it is possible to finance the purchase of the annuity contract and still derive positive spread from the arbitrage. For example, it is possible to borrow funds at an interest rate of about 6% and to invest the loan proceeds in a fixed annuity. The annual annuity proceeds may be sufficient to cover the interest on the loan and the premiums associated with a life insurance policy on the annuitant's life having a death benefit in excess of the loan principal. The excess spread (i.e., the remaining funds after the death benefit is collected and the loan is fully repaid) is net profit to the insured's family. Accordingly, what is needed are new investment products and methods that would allow variable life insurance policies to be created in compliance with the federal income tax requirements, while providing policy owners with opportunities to take advantage of the potential arbitrage between the annuity markets and the life insurance markets.

While the debt markets will loan money for the purchase of annuities, the interest rates charge by such lenders typically fluctuate. Conversely, while the yield on annuities can be fixed or variable to only a small degree, there is no guarantee of financial performance by either the annuity carriers or the insurance carriers. As a result, there is a chance that annuity proceeds could be insufficient to repay the loan if interest rates rise or if the annuity carrier(s) or the insurance carrier fails to perform. Therefore, lenders generally require that not only are such loans collateralized by the annuities, but that they are also guaranteed by the individual insured or a family member thereof. A general unwillingness by the public to accept such a credit risk must be overcome by any variable life product that is designed to capitalize on the potential arbitrage between the annuity markets and the life insurance markets.

In some situations, investors may be interested in making contributions to one or more charitable entities without subjecting the charity to income tax. Such investors might like to take advantage of arbitrage opportunities similar to those described above in order to maximize the charitable contribution resulting from their investment. At the same time, such investors may need or desire the option to benefit from arbitrage opportunities without the use of loans or variable life insurance products, for example, to simplify the investment structure. Therefore, investment products and methods are also needed that allow arbitrage entities to be created in compliance with the federal income tax requirements, while providing investors with opportunities to take advantage of the potential arbitrage between the annuity markets and the life insurance markets for the benefit of charitable institutions.

### SUMMARY OF THE INVENTION

The present invention satisfies the above-described needs by providing arbitrage investment products and methods for capitalizing on arbitrage opportunities between annuity markets and life insurance markets. In accordance with certain aspects of the invention, an arbitrage entity is formed to conduct and manage arbitrage transactions. The arbitrage entity may be a partnership, a corporation, a trust, a limited liability corporation, a limited liability partnership, or other business entity. The arbitrage entity can include a general partner, such as an investment adviser or other person or entity, who owns a general partnership interest; one or more limited partner, such one or more client, who owns a limited partnership interest; and one or more preferred partner who owns a preferred partnership interest. The preferred partner may provide a capital contribution to the arbitrage entity in exchange for the preferred partnership interest.

The one or more limited partner can contribute its limited partnership interest to one or more charitable entity. As a result, the one or more charitable entity can receive the limited partner's share of distributions during the life of the insured. Moreover, the one or more charitable entity can receive the limited partner distribution of any net arbitrage proceeds after the death of the insured.

The proceeds of the capital infusion are used to purchase one or more leveraged annuity on the life of one or more leveraged annuity client and a beneficial ownership interest in one or more leveraged life insurance policy on the life of one or more leveraged life insurance client. Periodic premium payments on the leveraged life insurance policy or policies are financed by periodic annuity proceeds generated by one or more leveraged annuity. The leveraged death benefit of the leveraged life insurance policy is typically greater than the proceeds of the capital infusion to provide profitable distributions.

Upon death of the leveraged life insurance client(s), the leveraged death benefit is paid to the arbitrage entity. The leveraged death benefit and remaining assets of the arbitrage entity are net arbitrage proceeds. The arbitrage entity may liquidate its assets and thereby distributes the net arbitrage proceeds in proportion to the ownership interests of its general, limited and preferred partners.

### BRIEF DESCRIPTION OF THE DRAWINGS

FIG. 1 is an abstract illustration of an exemplary variable life insurance product in accordance with certain exemplary embodiments of the present invention.

FIG. 2 is a block diagram illustrating certain exemplary investment methods of the present invention.

FIG. 3 is a block diagram illustrating the flow of funds upon the death of the client or other cause of termination of the insurance products involved in the exemplary investment methods illustrated in FIG. 2.

FIG. 4 is a block diagram illustrating certain alternative exemplary investment methods of the present invention.

FIG. 5 is a block diagram illustrating the flow of funds upon the death of the client or other cause of termination of the insurance products involved in the exemplary investment methods illustrated in FIG. 4.

### DETAILED DESCRIPTION OF EXAMPLARY EMBODIMENTS OF THE INVENTION

Exemplary embodiments of the present invention provide tax efficient investment products and methods for capitalizing on arbitrage opportunities between annuity markets and life insurance markets. In particular, some exemplary embodiments of the present invention provide investment methods based on an inventive variable life insurance product that is designed to have a cash value, in the form of death benefits upon death of an insured, based upon potential arbitrage gains between the proceeds of one or more “leveraged annuity” (defined below) on the life of one or more client and the proceeds of one or more “leveraged life insurance policy” (defined below) on the life of one or more client. The inventive variable life insurance product is carefully designed and managed so as to comply with stringent requirements of the Internal Revenue Code, including investor control and diversification rules. In addition, the risk inherent in the inventive investment methods are sufficiently minimized such that lenders are more likely to finance the arbitrage transaction without a personal guarantee of the loan by the client(s).

Other exemplary embodiments of the present invention provide investment methods outside of the variable life insurance context. Such investment methods involve the formation of an arbitrage entity for conducting and managing arbitrage transactions. Arbitrage proceeds, which again may be based upon potential arbitrage gains between leveraged annuities and leveraged life insurance policies, may be donated to a charitable entity. The investment methods of these other exemplary embodiments thus provide a non taxable investment option for charitable contributions of arbitrage proceeds. If desired, the investment methods of these other exemplary embodiments may be financed by private individuals or entities, rather than by institutional lenders.

For clarity, the term “client” is used herein to generally refer to a person on whose life a leveraged life insurance policy and/or a leveraged annuity is issued. A client may or may not render any payments or receive any direct benefits in connection with the inventive investment products and methods described herein. The term “leveraged life insurance client” is sometimes used to specifically refer to a client on whose life a leveraged life insurance policy is issued and the term “leveraged annuity client” is sometimes used to specifically refer to a client on whose life a leveraged annuity is issued. A leveraged life insurance client may or may not be the same person as a leveraged annuity client.

The term “insured” is used herein to refer to a person on whose life the inventive variable life insurance policy is issued. A client and an insured may or may not be the same person. In certain embodiments of the invention, an insured, a leveraged life insurance client, and a leveraged annuity client may each be the same individual. In other embodiments, an insured, a leveraged life insurance client, and a leveraged annuity client may each be different individuals.

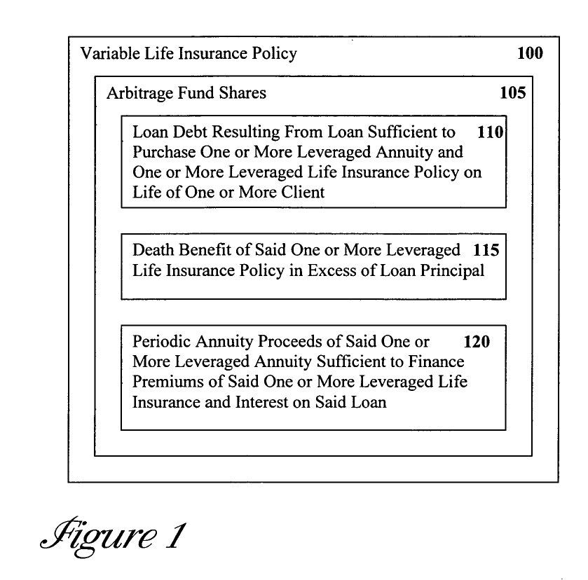

Referring now to the drawings, in which like numerals represent like elements throughout the several figures, exemplary embodiments of the present invention will be described. FIG. 1 illustrates a representative variable life insurance product in accordance with certain exemplary embodiments of the present invention. The inventive variable life insurance product may be, for example, a private placement policy or any other variable life insurance policy 100 that is designed by an insurance company to include the features described herein. The policyholder of the variable life insurance policy 100 may be a client, a family member of a client, an entity owned or controlled by a client or a client's family (e.g., a trust), a charitable organization, or any other person or entity having an insurable interest in the insured. The insured under the variable life insurance policy 100 will typically be one or more client, but could also be one or more other members of a client's family or anyone else in whom the policyholder has an insurable interest. In certain embodiments, the variable life insurance policy could be a survivorship policy.

The variable life insurance policy 100 is managed by an independent fund manager, who allocates fund balances between various investment categories. The insurance company, also referred to as the carrier, creates a fund category (referred to herein as an “arbitrage fund”), which consists of partnerships or other business entities (referred to herein as an “arbitrage entities”) that invest to exploit the arbitrage opportunities between the annuity and life insurance markets. The variable life insurance policy 100 includes a premium obligation that obligates the policyholder to make at least one premium payment to the insurance company. At least a portion of the premium payment is allocated to a segregated account held by the insurance company for the benefit of the policyholder.

The cash value of the variable life insurance policy 100 is determined based on the value of the assets contained within the segregated account. In order to capitalize on potential arbitrage benefits between the annuity and life insurance markets, the designated fund manager purchases shares of the arbitrage fund established by the insurance company. The arbitrage fund holds an interest in one or more arbitrage entity which directly or indirectly holds one or more annuity and one or more life insurance policy on the life of one or more client. The arbitrage fund shares 105 are then allocated into the segregated account of the variable life insurance policy 100. In certain embodiments, as will be explained below, the arbitrage fund may hold an interest in a single arbitrage entity that holds the one or more annuity and one or more life insurance contract on the life of one or more client. In other embodiments, the segregated account of the variable life insurance policy 100 could include arbitrage fund shares 105 of multiple arbitrage funds.

The one or more life insurance policy held by the arbitrage entity is referred to herein as a “leveraged life insurance policy” and the death benefit thereof is referred to herein collectively as a “leveraged death benefit” 115 because the premium payments toward the policy are financed by annuity proceeds from the one or more annuity on the life of one or more client. Similarly, the one or more annuity held by the arbitrage entity is referred to herein as a “leveraged annuity” because its purchase price is preferably financed by a loan or equity in the entity which has characteristics similar to a loan. In order to create potential arbitrage opportunities, the loan should be of an amount that is less than the leveraged death benefit 115, but sufficient to purchase both the one or more leveraged annuity and the initial premium(s) on one or more leveraged life insurance policy. Thus, the assets of the segregated account supporting the variable life insurance policy 100 effectively include a beneficial ownership interest in the leveraged death benefit 115 and the periodic annuity proceeds 120 of the leveraged annuity. Whereas, the loan debt 110 is a liability of the segregated account supporting the variable life insurance policy 100.

In accordance with certain embodiments of the invention, the leveraged life insurance policy is a whole life policy and the leveraged annuity is a fixed or guaranteed annuity. However, in other embodiments, the leveraged life insurance policy could be a universal life, term or variable policy or any combination thereof and/or the leveraged annuity could be a variable annuity payable for life or for a term of years. In accordance with certain embodiments, the loan used to finance the at least one leveraged annuity and the initial premium on at least one leveraged life insurance policy is a non-recourse loan with a fixed interest rate. In other embodiments, however, the loan could be a recourse loan and/or could have a floating interest rate. The loan could also be dollar denominated, non-dollar denominated, or structured as equity in the entity, which has characteristics similar to a loan.

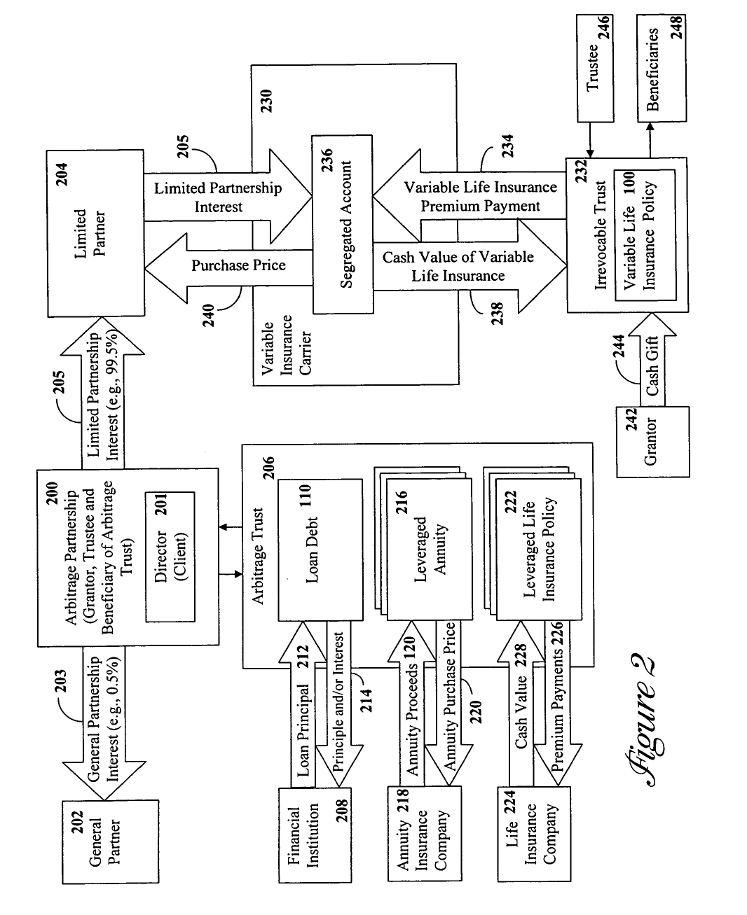

FIG. 2 is a block diagram illustrating certain exemplary investment methods of the present invention. In accordance with certain embodiments, the arbitrage entity may be a partnership (referred to herein as an “arbitrage partnership” 200), such as a limited partnership. A limited partnership offers certain advantages with respect to treatment of taxes and liabilities. For example, limited partnerships are not taxable entities. They are “flow through” entities that file tax returns allocating income or loss to the individual partners in accordance with the partnership agreement.

A limited partnership includes at least one general partner who is the manager and is personally liable for all debts and obligations of the partnership. Limited partners have no liability for partnership obligations, but cannot take part in management of the partnership. In other embodiments, the arbitrage entity may be another type of business entity, such as a general partnership, corporation, trust, limited liability corporation, limited liability partnership, etc. The choice of one of these other types of entities could have different consequences with respect to taxes and liabilities, but may nonetheless be appropriate in certain embodiments.

The exemplary arbitrage partnership 200 shown in the FIG. 2 has two partners, a general partner 202 and a limited partner 204. The general partner 202 is intended to hold only a small general partnership interest 203 in the arbitrage partnership 200 (for example, 0.5%), but maintain control over the investments of the arbitrage partnership 200. The limited partnership interest 205 held by the limited partner 204 is intended to be the majority interest in the arbitrage partnership 200 (for example, 99.5%). In other embodiments, the arbitrage partnership 200 may have multiple limited partners 204 and/or multiple general partners 203. Other ownership structures may be employed depending on such things as the nature of the arbitrage entity and the laws under which the arbitrage entity is formed.

The arbitrage partnership 200 is organized in a manner that allows it to have an insurable interest in the one or more client. For example, the arbitrage partnership 200 may create an insurable interest in a client by naming the client as director 201 of the arbitrage partnership 200. As another example, the arbitrage partnership 200 may include an independent advisory board, of which one or more client may be a member. There are many other ways to ensure that the arbitrage partnership 200 has an insurable interest in a client and the exact approach will vary depending on the applicable state laws governing insurable interests.

The arbitrage partnership 200 may itself invest in the potential arbitrage between the annuity and life insurance markets or may form a subsidiary or other related entity to make such arbitrage investments. The exemplary embodiment illustrated in FIG. 2 contemplates the use of a revocable trust (referred to herein as an “arbitrage trust” 206) in order to make such arbitrage investments. An arbitrage trust 206 may be structured to serve as a bankruptcy remote entity that insulates the arbitrage investment assets from a potential bankruptcy situation of the arbitrage partnership 200. Thus, the arbitrage trust 206 may be perceived as reducing the risk borne by the lender that finances the arbitrage transactions. Other benefits, such as potential tax benefits, of an arbitrage trust 206 will be apparent to those of skill in the art. Although the use of an arbitrage trust 206 is preferred in certain embodiments, the present invention is not intended to be so limited.

In the example of FIG. 2, the arbitrage trust 206 initiates its arbitrage investments by taking out a loan from an unrelated financial institution 208, such as a bank or other lender. The arbitrage trust 206 may acquire the loan from a financial institution 208 that offers the most attractive terms. One or more loan may be obtained by the arbitrage trust 206. Again, the loan (or loans) may be on a non-recourse or recourse basis, depending on risk tolerance and other market factors. The loan principal 212 is received by the arbitrage trust 206 and the resulting loan debt 110, i.e., obligation to make periodic (e.g., annual) principal and interest payments 214, becomes a liability of the arbitrage trust 206.

A portion of the loan proceeds (loan principal 212 less after any applicable fees, charges or other expenses deducted therefrom) is then used to acquire one or more leveraged annuity 216 on the life of one or more annuity client from an annuity insurance company 218, also referred to as an annuity carrier. The selection of the annuity insurance company 218 may be based upon a number of factors, including the nature of the loan (recourse, non recourse, etc.) obtained by the arbitrage trust 206, risk tolerance, quoted annuity proceeds 120 and annuity purchase prices 220. In addition, a portion of the loan proceeds are used by the arbitrage trust 206 to acquire one or more leveraged life insurance policy 222 on the life of one or more leveraged life insurance client, of which the arbitrage trust 206 will be the owner and beneficiary.

The one or more leverage life insurance policy 222 could be whole, universal, variable or any other kind of permanent life insurance. Term insurance may also be acquired in certain embodiments. The one or more leverage life insurance policy 222 may be purchased from one or more insurance company 224. The arbitrage trust 206 will preferably purchase as much life insurance on the life of the leveraged life insurance client(s) as the cash flow from the one or more leveraged annuity 216 will sustain. In certain exemplary embodiments, the one or more leveraged life insurance policy 222 is preferably a guaranteed contract, which will pay a specified death benefit regardless of the economic performance of the contract's underlying investments or the economic performance of the insurance company 224, provided that premium payments 226 are made on a timely basis.

The one or more leveraged annuity 216 is preferably a fixed annuity contract, because the periodic (e.g., annual) annuity proceeds 120 are a sum certain. However, depending on the risk tolerance of the arbitrage trust 206, the one or more leveraged annuity 216 may be a variable annuity or a combination of fixed and variable annuities. In certain embodiments, the loan proceeds are used to purchase five or more leveraged annuities 216 on the life of one or more leveraged annuity client, issued by one or more annuity companies 218, so as to ensure that the assets of the arbitrage trust 206 satisfy the diversification requirements of the Internal Revenue Code. In other embodiments, such diversification requirements could be satisfied through the purchase of multiple leveraged annuities 216 and multiple leveraged life insurance policies 222 on the life one or more client.

The arbitrage trust 206 will use the periodic annuity proceeds 120 from the one or more leveraged annuity 216 to pay the premium payments 226 of the one or more leveraged life insurance policy 222 and to make principal and/or interest payments 214 on the bank loan. In certain embodiments, the arbitrage trust may make interest-only payments 214 against the loan, until the death benefit of the one or more leveraged life insurance policy 222 is received. The loan may be secured by the one or more leveraged annuity 216 and by the one or more leveraged life insurance policy 222. As should now be apparent, arbitrage opportunities exist where the loan can be used to finance the purchase of the one or more leveraged annuity 216 and the one or more leveraged life insurance policy 222, where the annuity proceeds 120 can be used to finance the premium payments 226 of the one or more leveraged life insurance policy 222 and at least the interest payments 214 on the loan, and where the death benefit of the one or more leveraged life insurance policy 222 exceeds the outstanding balance of the loan.

The above-described arbitrage investments of the arbitrage entity are used to support the variable life insurance policy 100 of the present invention. As described above, a variable life insurance carrier 230, which may be the same or a different carrier than the life insurance company (or companies) that issued the one or more leverage life insurance policy 222, may issue the variable life insurance policy 100 on the life of one or more insured. Again the insured may be a client and/or a family member of a client and/or anyone else in whom the policyholder has an insurable interest. Similarly, the policyholder may be a client, a family member of the client, an entity owned or controlled by a client and/or a client's family, a charitable organization or any other person or entity that has an insurable interest in the insured under the variable life insurance policy 100. In the example shown in FIG. 2, the policyholder is an irrevocable trust 232, which may be a family trust, a charitable trust, etc.

At least one variable life insurance premium payment 234 is made to the variable insurance carrier 230 in exchange for the variable life insurance policy 100. In certain embodiments, the variable life insurance premium payment 234 consists of a single premium payment. Any variable life insurance premium payment 234 is allocated to the segregated account 236 of the variable insurance carrier 230. The manager of the segregated account 236 uses the funds therein to purchase the limited partnership interest 205 of the arbitrage partnership 200 from the limited partner 204.

Again, in certain exemplary embodiments, the limited partnership interest 205 represents approximately a 99.5% interest in the arbitrage partnership 200. The purchase price 240 of the limited partnership interest 205 may be any negotiated amount, but is preferably an amount not exceeding the variable life insurance premium payment 234 paid into the segregated account 236. In any event, the purchase price 240 should correspond to the estimated fair market value of the limited partnership interest 205, as supported by an independent appraisal from a reputable valuation firm. The variable life insurance premium payments 234 may be paid by the irrevocable trust 232 using funds gifted to it by its grantor 242 (shown in FIG. 2 as the cash gift 244).

Those familiar with the legalities of trusts will appreciate that many different types of trusts, both revocable and irrevocable, may be used to own a variable life insurance policy 100 and receive its resulting death benefits, depending on the intended purposes of the trust. For example, the contemplated irrevocable trust 232 may be structured so that the death benefit of the variable life insurance policy 100 is not included in the taxable estate of the insured, thus avoiding the imposition of estate taxes on the insurance proceeds in the insured's taxable estate. In certain exemplary embodiments, the intended purposes of the irrevocable trust 232 may also include shielding the grantor 242, trustee 246 and beneficiaries 248 from any liabilities incurred by the irrevocable trust 232. Thus, the irrevocable trust 232 may need to be carefully designed and managed in accordance with accepted practices in order to accomplish these or any other intended purposes.

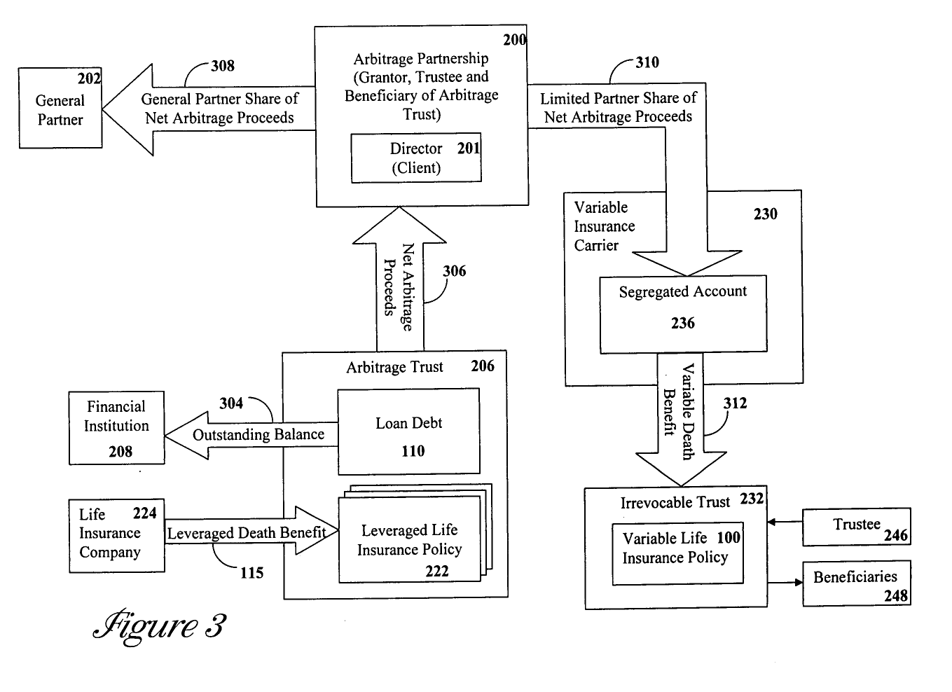

FIG. 3 is a block diagram illustrating the flow of funds upon the death of the one or more leveraged life insurance client (and/or insured), or other cause of termination of the one or more leveraged life insurance policy 222, the one or more leveraged annuity 216 and the variable life insurance policy 100 involved in the exemplary investment methods illustrated in and described with respect to FIG. 2. Upon such occurrence or occurrences, the arbitrage trust 206 will cease to receive the leveraged annuity proceeds 120, but will collect the death benefit of the one or more leveraged insurance life policy 222 (referred to collectively herein as the “leveraged death benefit” 115.) The arbitrage trust 206 will then make a payment to the financial institution 208 in the amount of the outstanding balance 304 of the loan (i.e., the loan principal plus any unpaid accrued interest.) Any net proceeds that remain after repayment of the loan are referred to herein as net arbitrage proceeds 306.

The arbitrage trust 206 distributes any net arbitrage proceeds 306 to the arbitrage partnership 200. The arbitrage partnership 200, in turn, distributes the net arbitrage proceeds 306 to its partners. For example, the arbitrage partnership may liquidate its assets in order to make a distribution thereof to its partners. Accordingly, in the example shown in FIG. 2 and FIG. 3, the general partner 202 receives a general partner share 308 (equal to the general partnership interest 203, e.g., 0.5%) of the net arbitrage proceeds 306 and the segregated account 236 associated with the variable life insurance policy 100 will receive a limited partner share 310 (equal to the limited partnership interest 205 e.g., 99.5%) of the net arbitrage proceeds 306. The death benefit of the variable life insurance policy 100 (referred to herein as the “variable death benefit” 312) thus includes the limited partner share 310 of the net arbitrage proceeds 306. The variable death benefit 312 is distributed by the variable insurance carrier 230 to the irrevocable trust 232 and/or other beneficiary of the variable life insurance policy 100.

Once an asset of the irrevocable trust 232, the variable death benefit 312 should not subject to income taxation or estate taxation. The trustee 246 manages the assets of the irrevocable trust 232 in accordance with the trust instrument. If authorized the do so, the trustee 246 may purchase assets of or make loans to the estate of a client (or an insured) in order to cover estate taxes and/or other expenses. Thus, certain embodiments of the present invention can provide, among other benefits, liquidity to meet future estate tax burdens. The invention can also make permanent life insurance coverage an option for families who might not otherwise be able to afford such protection.

In order to maximize the net arbitrage proceeds 306 and thus the variable death benefit 312 available to the beneficiary of the variable life insurance policy 100, the optimum amounts of the loan, the one or more leveraged annuity 216 and the one or more leveraged life insurance policy 222 that must be obtained by the arbitrage entity need to be determined. As stated above, the general goal of the arbitrage entity should normally be to purchase as much life insurance as the annual cash flow from the one or more leveraged annuity 216 will permit. However, the annual cash flow generated by the one or more leveraged annuity 216 is dictated by the amount of the loan obtained to purchase the leveraged annuity 216. Thus, optimization of the exemplary arbitrage transactions involves solving two simultaneous equations involving three inter-dependent variables: the amount of loan, the purchase price of the leveraged annuity 216, and the amount of periodic (e.g., annual) premium payment 226 for leveraged life insurance policy 222.

In accordance with certain exemplary embodiments, the two simultaneous optimization equations are as follows:

A=L-F−O-P; and (i)

A*X=(R*L)+C+P, (ii)

where ‘A’ represents the purchase price of the one or more leveraged annuity 216; ‘L’ represents the gross loan amount obtained from the lender; ‘F’ represents any loan finance charge (usually expressed as a percentage of the gross loan amount ) that may be charged by the lender; ‘O’ represents the sum of all one time costs of establishing the exemplary arbitrage transactions that are payable out of the loan proceeds; ‘X’ represents the applicable annuity payment rate quoted by the annuity carrier for the client; ‘R’ represents the annual interest rate on the loan; ‘C’ represents the sum of all annual costs or other reserves to be funded out of the annuity proceeds; and ‘P’ represents the annual premium payment 226 for the one or more leveraged life insurance policy 222.

Thus, the amount of money available to purchase the one or more leveraged annuity 216 is equal the net loan proceeds (i.e., gross loan proceeds minus any applicable finance charge) less the initial life insurance premium 226 less any other costs required for establishing the exemplary arbitrage transactions. Any such other costs required for establishing the exemplary arbitrage transactions will be known in advance and are effectively constant. Simultaneously, the annual annuity payment rate (a factor also known in advance) is multiplied by the amount of the one or more leveraged annuity 216 to determine the annual annuity proceeds 120. The amount of money available to be used as an annual premium payment 226 for the one or more leveraged life insurance policy 222 equals the annual annuity proceeds 120 less annual loan interest expense (i.e., the gross loan amount multiplied by the applicable interest rate) and less any annual fixed costs and reserves. Once the amount of the annual premium payment 226 is calculated, the quotes for the cost of the one or more leveraged life insurance policy 222 will permit the calculation of the leveraged death benefit 115.

In most cases, at least one of the three inter-related variables (‘L,’ ‘A’ and ‘P’) is constrained. For example, the maximum gross loan amount may be dictated by the available lenders. Also, in some circumstances, there may be a limited amount of leveraged life insurance coverage or a limitation on the amount of the annuity contracts available to a client. When one or more inter-related variable is constrained, it is treated as a constant and the above optimization equations are solved for the remaining variables.

The foregoing exemplary embodiments of the present invention utilize variable life insurance products to provide tax efficient investment products and methods for capitalizing on the potential arbitrage opportunities that exist between the annuity and life insurance markets. As mentioned, other exemplary embodiments of the present invention are designed to provide arbitrage investment opportunities outside of the context of variable life insurance products. For example, certain other embodiments of the present invention are designed to provide for tax efficient charitable donations of arbitrage proceeds. Some of these other exemplary embodiments are described hereafter.

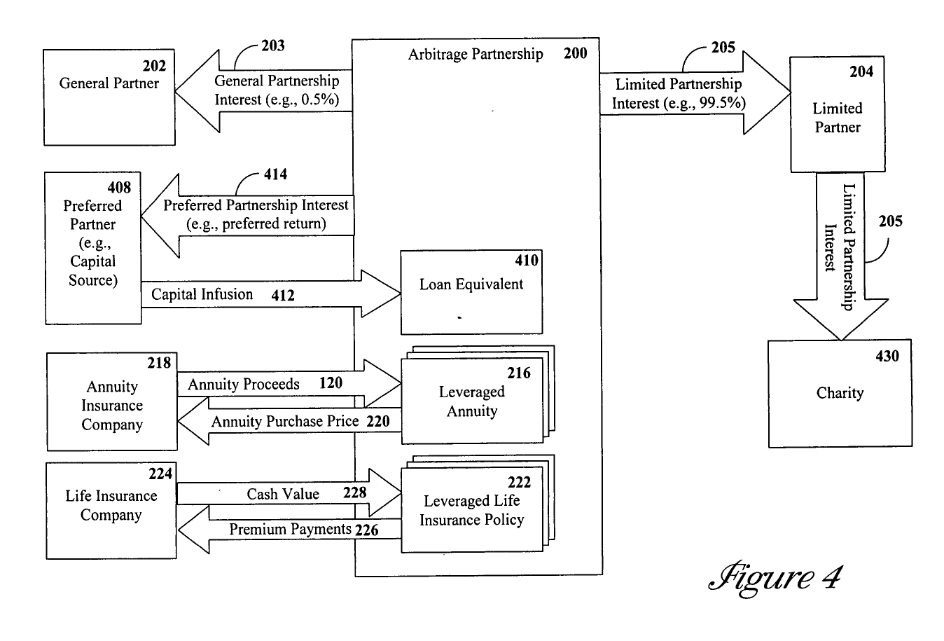

FIG. 4 is a block diagram illustrating certain exemplary investment methods of the present invention outside the context of a variable life insurance policy. In such embodiments, an arbitrage entity is again formed to conduct and manage arbitrage transactions. As described with reference to FIG. 2, the arbitrage entity may be an arbitrage partnership 200, such as a limited partnership. Moreover, the arbitrage entity 200 can be another type of business entity, such as a general partnership, corporation, trust, limited liability corporation, limited liability partnership, etc. in accordance with other alternative exemplary embodiments of the present invention. As discussed above, such choice of one of these other types of entities could have different consequences with respect to taxes and liabilities, but may still be appropriate in certain embodiments.

In example of FIG. 4, the arbitrage partnership 200 typically has at least three partners. In certain embodiments, the three partners may include a general partner 202, a limited partner 204, and a preferred partner 408. The preferred partner 408 is typically also the source of capital used to finance the arbitrage transactions of the arbitrage partnership 200, as will be discussed further below. The general partner 202 is intended to hold only a small general partnership interest 203 in the arbitrage partnership 200 (for example, 0.5%), but maintain control over the investments of the arbitrage partnership 200. The limited partnership interest 205 held by the limited partner 204 is intended to be the majority interest in the arbitrage partnership 200 (for example, 99.5%).

Those skilled in the art will appreciate that the term “partner” is used herein for convenience in describing certain embodiments of the invention in the context of an arbitrage partnership 200. In the context of other arbitrage entities (e.g., corporations, trusts, etc.), the “partners” described herein may be more properly referred to as “members,” “shareholders,” “stakeholders,” “directors,” etc. Therefore, the use of the term “partner” is not intended to limit the scope of the present invention to the context of arbitrage partnerships 200.

Those skilled in the art will also appreciate that within the context of an arbitrage partnership 200, a preferred partner 408 may be a general or limited partner who owns a preferred partnership interest 414. In certain embodiments, the preferred partner 408 is a limited partner who owns a preferred partnership interest 414. The preferred partner 408 may obtain the preferred partnership interest 414 in exchange for a capital infusion 412. The arbitrage partnership 200 may structure the preferred partner's interest as the economic equivalent of a loan. The preferred partnership interest 414 may provide a preferred return and/or a guaranteed repayment of the loan equivalent 410. The preferred partnership interest 414 could also be designed to yield a proportionate return on the capital infusion 412 with or without a cap on that return. In addition or as an alternative to the preferred return, the preferred partnership interest 414 might include a percentage ownership interest in the arbitrage partnership 200.

In some embodiments, the arbitrage partnership 200 may have multiple limited partners 204, multiple general partners 202, and/or multiple preferred partners 408. Furthermore, other ownership structures may be employed depending on such things as the nature of the arbitrage entity and the laws under which the arbitrage entity is formed. The arbitrage partnership 200 is organized in a manner that allows it to have an insurable interest in the one or more client. For example, the one or more client may be a limited partner 204 of the arbitrage partnership 200. If the one or more client is not a limited partner 204 or have any other partnership interest in the arbitrage partnership 200, an insurable interest may be created by naming the one or more client as director or member of an advisor board of the arbitrage partnership 200. There are numerous other ways to ensure that the arbitrage partnership 200 has an insurable interest in a client and the exact approach will vary depending on the applicable state laws governing insurable interests.

The arbitrage partnership 200 may itself invest in the potential arbitrage between the annuity and life insurance markets, as contemplated in FIG. 4, or may form a subsidiary or other related entity to make such arbitrage investments. For example, a revocable trust could be used to make such arbitrage investments. This revocable trust could be structured to serve as a bankruptcy remote entity that insulates the arbitrage investment assets from a potential bankruptcy situation of the arbitrage partnership 200. Moreover, other benefits, such as potential tax benefits, of using an arbitrage trust will be apparent to those of skill in the art. However, the arbitrage partnership 200 invests in the potential arbitrage between the annuity and life insurance markets in accordance with the alternative exemplary embodiments of the present invention.

In accordance with certain exemplary embodiments of the present invention, the arbitrage partnership 200 can be formed by a limited partner 204, such as a client, and a general partner 202, such as an investment adviser or firm. Thereafter, a preferred partner 408, such as a financial institution or other source of capital, can join the arbitrage partnership 200. Alternatively, however, the arbitrage partnership 200 can be initiated by a limited partner 204, a general partner 202, and a preferred partner 408 who all join in the partnership 200 at its inception. In any case, it possible for the arbitrage partnership 200 to include one or more general partner 202, one or more limited partner 204, and/or one or more preferred partner 408 in accordance with certain embodiments of the invention.

As is customary in the formation of partnerships, each participant may make an initial contribution to the arbitrage partnership 200. For example, the limited partner 204 may make a contribution of approximately $2500 to the partnership 200. The general partner 202 may make a smaller of contribution of approximately $1000. However, the preferred partner 408, as the capital source, may make a much larger contribution than the other partners, for example, $25,000,000. The preferred partner 408 contributes capital to the arbitrage partnership 200 as an equity contribution, in contrast to a loan, by providing a capital infusion 412 to the partnership 200. As mentioned before, the preferred partner 408 could be a financial institution or other entity that is capable of providing a sufficient capital infusion 412, including a private entity, group or individual.

Since the one or more preferred partner 408 makes a capital infusion 412 to the arbitrage partnership 200 instead of a loan, the arbitrage partnership 200 does not acquire loan debt that requires payments towards interest and principal. Instead, in accordance with an arbitrage partnership agreement, the preferred partner may be entitled to received a preferred return on the profits of the partnership 200 as well as the return of the capital infusion 412 if the partnership 200 dissolves. As mentioned, the capital infusion 412 is treated as a loan equivalent 410, which has different tax consequences than a loan debt would have. Those skilled in the art will appreciate the benefits of such a partnership structure, for example, since the capital source is brought into the arbitrage partnership 200 as a preferred partner 408 instead of a lender.

As discussed above, under a typical partnership agreement for the arbitrage partnership 200, the preferred partner 408 would receive a preferred return through its preferred limited partnership interest 414. This preferred return could be structured as a majority of the profit income to the arbitrage partnership 200. The residual profit income after the preferred distribution can be distributed to the general partner 202 and limited partner 204 in accordance with the partnership agreement. Therefore, all of the partners of the arbitrage partnership 200 will typically receive annual taxable income distributions.

In accordance with the exemplary embodiments illustrated by FIG. 4, the limited partner 204 may donate or transfer its limited partnership interest 205 to one or more charity 430. The one or more charity 430 may be an entity that the limited partner 204 intends to make contributions to and/or leave a gift to be received after the death of the limited partner 204. Furthermore, the one or more charity 430 can be any charitable entity, for example, a school or church, or other foundation. The limited partner 204 may transfer its limited partnership interest 205 to the one or more charity 430 either before or after the arbitrage partnership 200 makes any arbitrage transactions. As an alternative to the limited partner 204 transferring its limited partnership interest 205 to the one or more charity 430, the one or more charity 430 could itself be set up as a limited partner 204 at the inception of the arbitrage partnership 200. In either case, the charity 430 receives a limited partnership interest 205 of the arbitrage partnership 200 and is thus able to receive its share of distributions from the arbitrage partnership, as well as income allocations.

As discussed above, the arbitrage partnership 200 initiates its arbitrage investments by obtaining the capital infusion 412 from the preferred partner 408 in exchange for a preferred limited partnership interest 414. The arbitrage partnership 200 may select its preferred partner 408 from among the best available or most attractive capital sources. The terms, conditions and amounts of the preferred partnership interest 414 and the capital infusion 412 may be negotiated by the arbitrage partnership 200 and the preferred partner 408. The capital infusion 412 received by the arbitrage partnership 200 and the resulting loan equivalent 410 becomes an equity asset of the arbitrage partnership 200.

The arbitrage investments conducted and managed by the arbitrage partnership 200 in accordance with the embodiments illustrated in FIG. 4 can be similar to those described with respect to FIG. 2. That is, a portion of the capital infusion proceeds (e.g., the capital infusion 412 less any deducted expenses) can be used to acquire one or more leveraged annuity 216 on the life of one or more annuity client from an annuity insurance company 218, which can also referred to as an annuity carrier. As discussed with respect to FIG. 2, the selection of an annuity insurance company 218 may be based upon a number of factors, including risk tolerance, quoted annuity proceeds 120 and annuity purchase prices 220. Additionally, a portion of the capital infusion proceeds can be used by the arbitrage partnership 200 to acquire one or more leveraged life insurance policy 222 on the life of one or more leveraged life insurance client, of which the arbitrage partnership 200 will be the owner and beneficiary.

Again, the one or more leverage life insurance policy 222 could be whole, universal, variable or any other kind of permanent life insurance. Term insurance may also be acquired in certain embodiments. The one or more leverage life insurance policy 222 may be purchased from one or more life insurance company 224. The arbitrage partnership 200 may preferably purchase as much life insurance on the life of the leveraged life insurance client(s) as the cash flow from the one or more leveraged annuity 216 can sustain. In certain alternative exemplary embodiments, the one or more leveraged life insurance policy 222 may preferably be a guaranteed contract, which can pay a specified death benefit regardless of the economic performance of the contract's underlying investments or the economic performance of the insurance company 224, provided that premium payments 226 are made on a timely basis.

In addition, the one or more leveraged annuity 216 is preferably again a fixed annuity contract, because the periodic (e.g., annual) annuity proceeds 120 are a sum certain. However, depending on the risk tolerance of the arbitrage partnership 200, the one or more leveraged annuity 216 may be a variable annuity or a combination of fixed and variable annuities. Multiple leveraged annuities 216 and multiple leveraged life insurance policies 222 may be purchased on the life of one or more client. The leveraged annuity client may or may not be the same individual as the leveraged life insurance client.

As discussed above, the arbitrage partnership 200 can use the periodic annuity proceeds 120 from the one or more leveraged annuity 216 to pay the premium payments 226 of the one or more leveraged life insurance policy 222. The residual annuity proceeds 120, after deduction of the premium payments 226, can represent income to the arbitrage partnership 200, which can be distributed to the partners as discussed earlier. For example, some of annuity proceeds 120 can find the preferred return to the preferred partner 408. In certain embodiments of the present invention, arbitrage opportunities can exist when the capital infusion 412 can be used to finance the purchase of the one or more leveraged annuity 216 and the one or more leveraged life insurance policy 222, the annuity proceeds 120 can be used to fund the premium payments 226 of the one or more leveraged life insurance policy 222 and the annual returns to the arbitrage partners, and the death benefit 115 of the one or more leveraged life insurance policy 222 exceeds the balance of the loan equivalent 410.

The above-described arbitrage investments of the arbitrage partnership 200 can be used to provide annual distributions to the one or more charity 430 while also providing annual returns to the preferred partner and the general partner. As discussed above, the limited partner 204 typically transfers its limited partnership interest 205 to the one or more charity 430. As also discussed above, most of the profits to the arbitrage partnership 200 from the arbitrage investments will be allocated to the preferred partner 408 in accordance with the arbitrage partnership agreement. Therefore, the preferred partner 408 will be taxed for its income from the preferred return 414 similar to the tax liability it would incur if it were a lender obtaining interest income on a loan. The following illustrates one possible example of the cash flow in the arbitrage partnership 200 from the arbitrage investments.

By way of example, the arbitrage partnership 200 may acquire approximately $1,000,000 annually from the annuity proceeds 120. Furthermore, the insurance premium payments 226 may total approximately $400,000, which would leave about $600,000 remaining from the annuity proceeds 120 after the payment deductions. The preferred partner will typically receive most of the remaining proceeds 120. For example, the preferred partner may receive $570,000, and the remaining $30,000 would be distributed between the general partner and the limited partner in accordance with the terms of the partnership agreement. The partnership's taxable income would be allocated to the partners in accordance with the partnership agreement as well.

As will be understood by those skilled in the art, a main variant in how taxable income is allocated is whether the payment to the preferred partner is structured as a guaranteed payment or a preferred return. Income allocated to the charitable partner as a result of the arbitrage entity 200 would not create a tax liability to the charity unless the charity was a private foundation which would be subject to a one or two percent tax on this investment income.

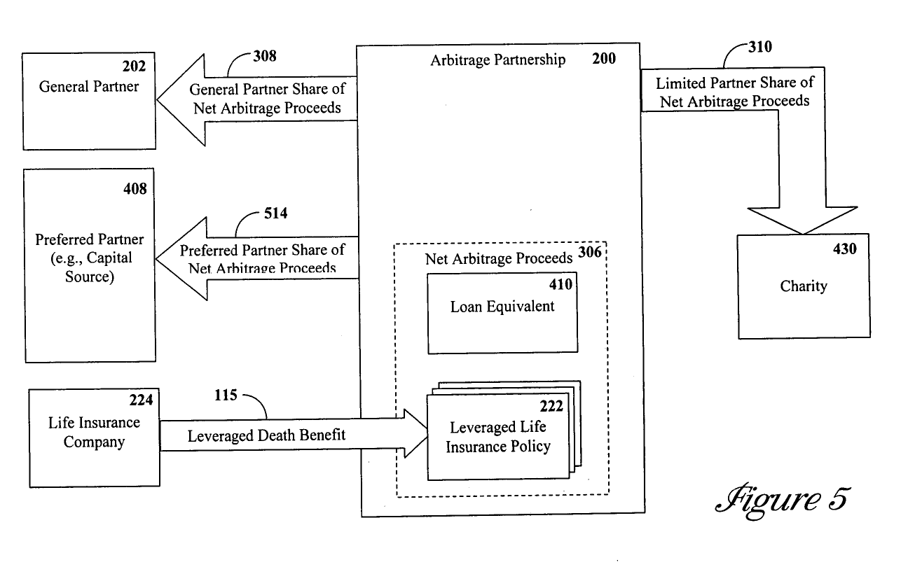

FIG. 5 is a block diagram illustrating the flow of funds upon the termination of the leveraged arbitrage transactions illustrated in FIG. 4. The leveraged arbitrage transactions terminate upon the death of the one or more leveraged life insurance client (and/or insured) or other cause of termination of the one or more leveraged life insurance policy 222 and the one or more leveraged annuity 216. Upon such occurrence or occurrences, the arbitrage partnership 200 will cease to receive the leveraged annuity proceeds 120, but will collect the leveraged death benefit 115 of the one or more leveraged insurance life policy 222. The leveraged death benefit 115 along with any remaining amount of the loan equivalent 410 and/or any other assets of the partnership 200 are referred to hereafter as the net arbitrage proceeds 306.

Depending on the terms of the partnership agreement of the arbitrage partnership 200, a portion of the net arbitrage proceeds 306 may first be distributed to the preferred partner 408 as a return on its capital investment (i.e., the capital infusion 412 contributed by the preferred partner 408.) The preferred partnership share 514 of the net arbitrage proceeds 306 may thus include any amount owed to the preferred partner 408 according to the partnership agreement, which may specify the priority of distributions. The remaining portion of the net arbitrage proceeds 306 would then be distributed to the other partners in accordance with the partnership agreement. For example, the general partner may receive a general partner share 308 (equal to the general partnership interest 203, e.g., 0.5%) and the limited partner share 310 may be distributed to the one or more charity 430. The arbitrage partnership 200 may or may not need to be dissolved in order to distribute net arbitrage proceeds to its owners.

As described above, the arbitrage partnership 200 may have more than one limited partner 204. Each limited partner 204 may represent a different client or charity 430 designated by that client. The arbitrage partnership may therefore conduct and manage arbitrage transactions on behalf of multiple clients, with distributions to be made to multiple charities 430. In order to fund multiple arbitrage transactions, the arbitrage partnership 200 may take on multiple preferred partners 408 for additional sources of capital. The partnership agreement may be designed such that the net arbitrage proceeds attributable to a particular client are distributed only to the charity 430 or charities of that client's choosing. Alternatively, upon the death of any one client, distributions may be made to each charity 430 or other entity holding a limited partnership interest 205 of the arbitrage partnership 200. In some cases, the arbitrage partnership 200 may wait until all arbitrage transactions have been completed before distributing any net arbitrage proceeds to the partners.

Based on the foregoing, it can be seen that the present invention provides tax efficient investment products and methods for capitalizing on the potential arbitrage opportunities that exist between the life insurance markets and the annuity markets and for making charitable contributions with any net arbitrage proceeds. Many other modifications, features and embodiments of the present invention will become evident to those of skill in the art. It should also be appreciated, therefore, that many aspects of the present invention were described above by way of example only and are not intended as required or essential elements of the invention unless explicitly stated otherwise. Accordingly, it should be understood that the foregoing relates only to certain embodiments of the invention and that numerous changes may be made therein without departing from the spirit and scope of the invention as defined by the following claims.

What is claimed is:

1. An arbitrage investment product for capitalizing on arbitrage opportunities between annuity markets and life insurance markets and for making a charitable contribution of any resulting arbitrage proceeds, comprising:
an ownership interest in an arbitrage entity, the arbitrage entity being funded by a capital infusion from at least one source of capital;
wherein the capital infusion is in an amount sufficient to purchase one or more leveraged annuity on the life of one or more leveraged annuity client and one or more leveraged life insurance policy on the life of one or more leveraged life insurance client;
wherein periodic annuity proceeds of the one or more leveraged annuity are sufficient to cover periodic premium payments on the one or more leveraged life insurance policy and periodic returns to the capital source;
wherein a leveraged death benefit of the one or more leveraged life insurance policy exceeds the amount of the capital infusion; and
wherein the ownership interest in the arbitrage entity is acquired by at least one charity.

2. The arbitrage investment product of claim 0, wherein the arbitrage entity is selected from the group consisting of: a partnership, a corporation, a trust, a limited liability corporation, and a limited liability partnership.

3. The arbitrage investment product of claim 0, wherein the charitable entity is defined by the United States Internal Revenue Code.

4. The arbitrage investment product of claim 0, wherein the capital infusion comprises a private investment in the arbitrage entity.

5. The arbitrage investment product of claim 0, wherein the arbitrage entity comprises an arbitrage partnership; and
wherein the ownership interest in the arbitrage entity comprises a limited partnership interest.

6. The arbitrage investment product of claim 5, wherein the arbitrage partnership further includes a general partner and one or more preferred partner;
wherein the general partner comprises an investment advisor who manages the arbitrage transactions of the arbitrage partnership; and
wherein the one or more preferred partner comprises the one or more capital source.

7. The arbitrage investment product of claim 6, wherein the one or more preferred partner is entitled to a preferred distribution of any income of the arbitrage partnership.

8. The arbitrage investment product of claim 0, wherein upon death of the one or more leveraged life insurance client, the arbitrage entity receives the leveraged death benefit;
wherein the leveraged death benefit and any remaining assets of the arbitrage entity comprise net arbitrage proceeds; and
wherein the arbitrage entity distributes the net arbitrage proceeds in accordance with the ownership interest.

9. The arbitrage investment product of claim 0, wherein at least one of the one or more leveraged life insurance client and the one or more leveraged annuity client are same person.

10. A method for investing in arbitrage opportunities between annuity markets and life insurance markets and for making a charitable contribution of any resulting arbitrage proceeds, comprising:
forming an arbitrage entity and causing the arbitrage entity to obtain a capital infusion from a capital source in an amount sufficient to purchase one or more leveraged annuity on the life of one or more leveraged annuity client and one or more leveraged life insurance policy on the life of one or more leveraged life insurance client;
wherein periodic annuity proceeds of the one or more leveraged annuity are sufficient to cover periodic premium payments on the one or more leveraged life insurance policy and periodic returns to the capital source;
wherein a leveraged death benefit of the one or more leveraged life insurance policy exceeds the amount of the capital infusion;
causing the arbitrage entity to purchase the one or more leveraged annuity and the one or more leveraged life insurance policy; and
donating an interest in the arbitrage entity to at least one charity.

11. The method of claim 10, wherein the capital infusion comprises a private investment in the arbitrage entity.

12. The method of claim 10, wherein the arbitrage entity comprises a partnership having two or more partners.

13. The method of claim 10, wherein the arbitrage entity comprises a partnership having a general partner, a limited partner, and a preferred partner;
wherein the general partner owns a general partnership interest in the arbitrage entity;
wherein the limited partner owns a limited partnership interest in the arbitrage entity; and
wherein the preferred partner owns a preferred partnership interest in the arbitrage entity.

14. The method of claim 13, wherein the preferred partner comprises the capital source and is granted the preferred partnership interest in exchange for the capital infusion.

15. The method of claim 13, wherein donating the interest in the arbitrage entity to the at least one charity comprises donating the limited partnership interest to the at least one charitable entity.

16. The method of claim 13, wherein the preferred partner is entitled to a priority distribution of any profits of the arbitrage partnership.

17. The method of claim 10, wherein upon death of the one or more leveraged life insurance client, the arbitrage entity receives the leveraged death benefit;
wherein the leveraged death benefit and any remaining assets of the arbitrage entity comprise net arbitrage proceeds; and
wherein the arbitrage entity liquidates its assets and thereby distributes the net arbitrage proceeds in accordance with any ownership interest in the arbitrage entity.

18. The method of claim 10, wherein at least one of the one or more leveraged life insurance client and the one or more leveraged annuity client are same person.
